(19) United States
(12) Patent Application Publication
(10) Pub. No.: US 2022/0135418 A1
(43) Pub. Date: May 5, 2022

(54) PRODUCTION OF HIGH PURITY ALUMINA AND CO-PRODUCTS FROM SPENT ELECTROLYTE OF METAL-AIR BATTERIES

(71) Applicant: PHINERGY LTD, Lod (IL)

(72) Inventor: Mark WEAVER, Greenwell Springs, LA (US)

(73) Assignee: PHINERGY LTD, Lod (IL)

(21) Appl. No.: 17/434,017

(22) PCT Filed: Apr. 5, 2020
(86) PCT No.: PCT/IL2020/050411

§ 371 Date: Aug. 26, 2021

Related U.S. Application Data
(60) Provisional application No. 62/834,417, filed on Apr. 16, 2019.

(51) Int. Cl. C01F 7/46; H01M 6/52

(52) U.S. Cl. CPC C01F 7/46; H01M 2300/0014; C01P 2006/80; H01M 6/52

(57) ABSTRACT

Methods and systems are provided, which convert spent electrolyte from aluminum-air batteries into high purity alumina (HPA) and useful co-products such as fertilizer(s) and/or feed supplement(s). Aluminum tri-hydroxide (ATH) having potassium (K) and/or sodium (Na) impurities, e.g., from spent electrolyte, may be dissolved in strong acid to form an acidic ATH solution having pH<4. Consecutively, the acidic ATH solution may be neutralized to pH>4 to precipitate ATH while retaining dissolved K/Na in the neutralized solution. The dissolving and the neutralizing may then be repeated with the precipitated ATH until a specified purity level of the precipitated ATH is reached. Using appropriate bases to neutralize the acidic ATH solution, e.g., ammonia and/or choline, yields useful co-products such as ammonium nitrate (with nitric acid as the strong acid) and choline chloride (with hydrochloric acid as the strong acid), respectively.

### BACKGROUND OF THE INVENTION

### 1. Technical Field

The present invention relates to the field of chemical processes, and more particularly, to production of high purity alumina (HPA).

### 2. Discussion of Related Art

High purity alumina (HPA) is a class of aluminum oxide materials with an overall purity >99.99 w % Al₂O₃ basis. HPA has seen dramatic growth in the last 3-4 years due to it being a necessary component in high end products such as light emitting diodes (LED's), synthetic sapphire glass (cell phone screens), semi-conductor wafers and Li ion batteries. The market for high purity alumina (HPA) was estimated to be 25,000 tons in 2015 with a compound annual growth rate (CAGR) estimate of 15-30% through 2025. Selling price is determined by purity level with 4N (99.99%) grade approximately 25,000 $/ton and 5N (99.999%) grade approximately 50,000 $/ton. The high price is due to the complex processing currently employed in manufacturing. Nearly all existing production uses high purity aluminum metal as the feedstock to multi-step chemical processing routes such as alkoxide hydrolysis, choline precipitation or alum thermal decomposition. These processes are practiced by the existing manufacturers such as Sumitomo Chemicals, Sasol (alkoxide hydrolysis); Heibi Pengda (choline precipitation): Baikowski, Zibo Xinfumeng (alum decomposition). Other producers (Orbite, Altech) have announced intention to commercialize a new HPA process based on acid dissolution purification of alumino-silicate clay ore.

### SUMMARY OF THE INVENTION

The following is a simplified summary providing an initial understanding of the invention. The summary does not necessarily identify key elements nor limit the scope of the invention, but merely serves as an introduction to the following description.

One aspect of the present invention provides a method comprising: dissolving aluminum tri-hydroxide (ATH) having potassium (K) and/or sodium (Na) impurities in at least one strong acid to form an acidic ATH solution having pH<4, neutralizing the acidic ATH solution to pH>4 to precipitate ATH while retaining dissolved K/Na in the neutralized solution, and repeating the dissolving and the neutralizing with the precipitated ATH until a specified purity level of the precipitated ATH is reached.

One aspect of the present invention provides a method comprising dissolving metal hydroxide residues of metal air battery operations, having alkaline impurities, in at least one strong acid to form an acidic metal hydroxide solution having pH<4, neutralizing the acidic metal hydroxide solution to pH>4 to precipitate metal hydroxide while retaining dissolved alkalinity in the neutralized solution, and repeating the dissolving and the neutralizing with the precipitated metal hydroxide until a specified purity level of the precipitated metal hydroxide is reached.

One aspect of the present invention provides a system comprising: at least one reactor configured to dissolve aluminum tri-hydroxide (ATH) having potassium (K) and/or sodium (Na) impurities in at least one strong acid to form an acidic ATH solution having pH<4, and to neutralize the acidic ATH solution to pH>4 to precipitate ATH while retaining dissolved K/Na in the neutralized solution, pipework configured to deliver the at least one strong acid and at least one neutralizing base to the at least one reactor, and to remove the retained dissolved K/Na in the neutralized solution from the at least one reactor, and a controller configured to repeat the dissolving and the neutralizing with the precipitated ATH until a specified purity level of the precipitated ATH is reached.

One aspect of the present invention provides a system comprising at least one reactor configured to dissolve metal hydroxide residues of metal air battery operations, having alkaline impurities, in at least one strong acid to form an acidic metal hydroxide solution having pH<4, and to neutralize the acidic metal hydroxide solution to pH>4 to precipitate metal hydroxide while retaining dissolved alkalinity in the neutralized solution, pipework configured to deliver the at least one strong acid and at least one neutralizing base to the at least one reactor, and to remove the retained dissolved alkalinity in the neutralized solution from the at least one reactor, and a controller configured to repeat the dissolving and the neutralizing with the precipitated metal hydroxide until a specified purity level of the precipitated metal hydroxide is reached.

These, additional, and/or other aspects and/or advantages of the present invention are set forth in the detailed description which follows; possibly inferable from the detailed description; and/or learnable by practice of the present invention.

### BRIEF DESCRIPTION OF THE DRAWINGS

For a better understanding of embodiments of the invention and to show how the same may be carried into effect, reference will now be made, purely by way of example, to the accompanying drawings in which like numerals designate corresponding elements or sections throughout.

In the accompanying drawings:

FIG. 1 is a high-level schematic block diagram of systems, according to some embodiments of the invention.

FIG. 2 is a high-level flowchart illustrating methods, according to some embodiments of the invention.

### DETAILED DESCRIPTION OF THE INVENTION

In the following description, various aspects of the present invention are described. For purposes of explanation, specific configurations and details are set forth in order to provide a thorough understanding of the present invention. However, it will also be apparent to one skilled in the art that the present invention may be practiced without the specific details presented herein. Furthermore, well known features may have been omitted or simplified in order not to obscure the present invention. With specific reference to the drawings, it is stressed that the particulars shown are by way of example and for purposes of illustrative discussion of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

Before at least one embodiment of the invention is explained in detail, it is to be understood that the invention is not limited in its application to the details of construction and the arrangement of the components set forth in the following description or illustrated in the drawings. The invention is applicable to other embodiments that may be practiced or carried out in various ways as well as to combinations of the disclosed embodiments. Also, it is to be understood that the phraseology and terminology employed herein are for the purpose of description and should not be regarded as limiting.

Embodiments of the present invention provide efficient and economical methods and mechanisms for producing high purity alumina (HPA) as well as for co-production of HPA and fertilizer and/or feed supplements. Methods and systems are provided, which convert spent electrolyte from aluminum-air batteries into HPA and useful co-products such as fertilizer(s) and/or feed supplement(s). Aluminum tri-hydroxide (ATH) having potassium (K) and/or sodium (Na) impurities, e.g., from spent electrolyte, may be dissolved in strong acid to form an acidic ATH solution having pH<4. Consecutively, the acidic ATH solution may be neutralized to pH>4 to precipitate ATH while retaining dissolved K/Na in the neutralized solution. The dissolving and the neutralizing may then be repeated with the precipitated ATH until a specified purity level of the precipitated ATH is reached. Using appropriate bases to neutralize the acidic ATH solution, e.g., ammonia and/or choline, yields useful co-products such as ammonium nitrate (with nitric acid as the strong acid) and choline chloride (with hydrochloric acid as the strong acid), respectively.

Certain embodiments comprise processes that convert battery-derived aluminum hydroxide solid into >99.99 w % high purity alumina while co-producing valuable fertilizer and feed supplement chemical products. Aluminum-air batteries use high purity aluminum metal to electrochemically produce electricity. During battery operation, both the high purity aluminum metal and the potassium/sodium hydroxide liquid electrolyte are consumed. The resulting liquid consists of aluminum dissolved in the electrolyte as liquid potassium/sodium aluminate solution. A regeneration process has previously been developed that converts this solution into solid aluminum hydroxide and regenerated/reusable potassium/sodium hydroxide electrolyte. Although the aluminum used in the battery is initially very high purity (>99.99% Al), the aluminum hydroxide, resulting from the regeneration process, contains substantial quantities of potassium/sodium impurity (>0.5 w %) not readily removed by conventional washing.

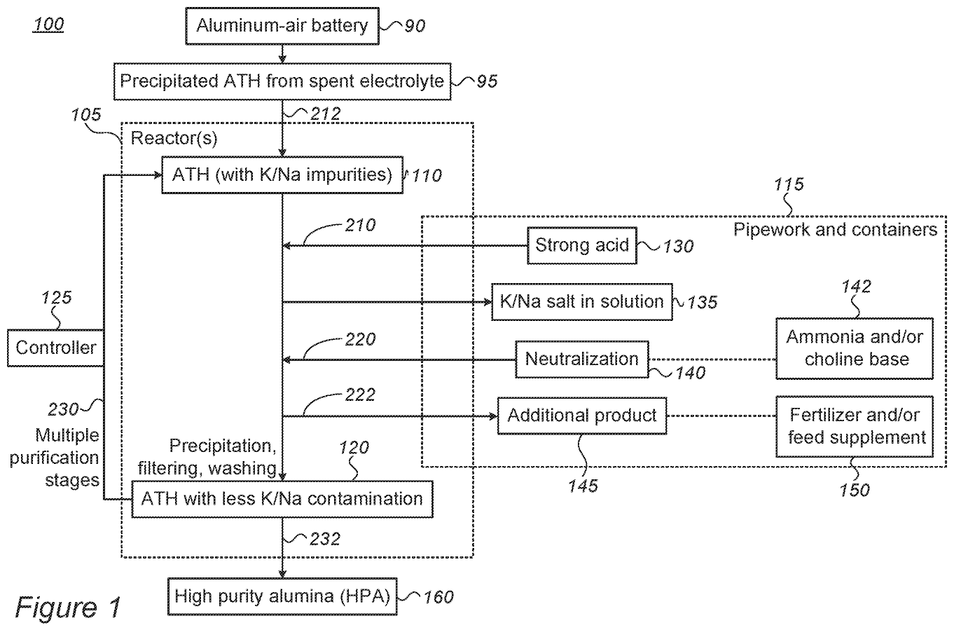

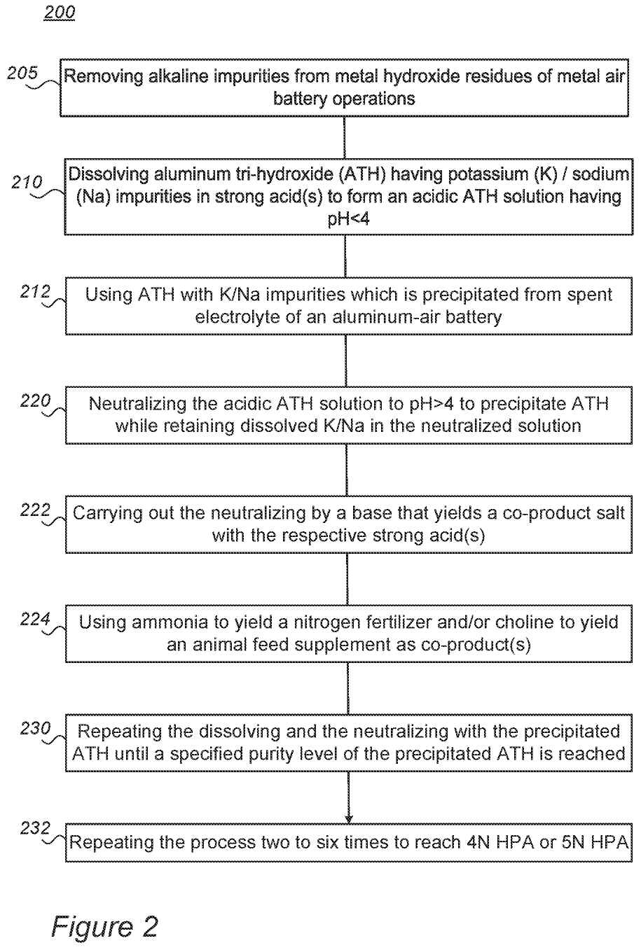

FIG. 1 is a high-level schematic block diagram of a system 100, according to some embodiments of the invention. It is noted that system 100 is described schematically, in terms of the materials that are being handled by system 100, and that system 100 comprises containers, reactors, pipework etc. which is not shown in detail in the schematic illustration. FIG. 2 is a high-level flowchart illustrating a method 200, according to some embodiments of the invention. The method stages may be carried out with respect to system 100, which may optionally be configured to implement method 200. Method 200 may comprise the following stages, irrespective of their order.

System 100 comprises at least one reactor 105 configured to dissolve aluminum tri-hydroxide (ATH) having potassium (K) and/or sodium (Na) impurities 110 in at least one strong acid 130 to form an acidic ATH solution having pH<4, and to neutralize the acidic ATH solution to pH>4 to precipitate ATH 120 while retaining dissolved K/Na in the neutralized solution 135. System 100 further comprises pipework 115 (indicated schematically, possibly further comprising containers and/or sources for acid(s) 130, bases(s) 142, solution(s) 135 and products 145) configured to deliver strong acid(s) 130 and neutralizing base(s) 142 to reactor(s) 105, and to remove retained dissolved K/Na in the neutralized solution 135 and/or additional product(s) 145 from reactor(s) 105. System 100 further comprises a controller 125 configured to repeat the dissolving and the neutralizing with the precipitated ATH (120→110) until a specified purity level of the precipitated ATH is reached to yield high purity alumina (HPA) 160.

Correspondingly, method 200 comprises dissolving ATH having K/Na impurities in at least one strong acid to form an acidic ATH solution having pH<4 (stage 210), neutralizing the acidic ATH solution to pH>4 to precipitate ATH while retaining dissolved K/Na in the neutralized solution (stage 220), and repeating the dissolving and the neutralizing with the precipitated ATH until a specified purity level of the precipitated ATH is reached (stage 230).

ATH with K/Na impurities 95 may be provided by precipitation from spent electrolyte of an aluminum-air battery (stage 212), to convert the spent electrolyte by-product into valuable product HPA. For example, method 200 may comprise using ATH received, at least partly from spent electrolyte of aluminum-air battery operation, or, more generally, embodiments of method 200 may be applied, at least partly, to metal hydroxide residues of metal air battery operations. It is noted that any of the disclosed embodiments may be applied to other metal-air batteries such as Zn-air, yielding corresponding high purity materials, such as high purity ZnO₂.

In certain embodiments, systems 100 and/or methods 200 may comprise removing alkaline impurities from metal hydroxide residues of metal air battery operations (stage 205), with disclosed ATH, possibly received as the metal hydroxide residues of aluminum air battery operations, as a non-limiting example.

In various embodiments, strong acid(s) 130 may comprise at least one of hydrochloric (HCl), sulfuric (H₂SO₄) and nitric (HNO₃) acids.

In various embodiments, neutralization 140 (and neutralizing stage 220) may be carried out by base(s) 142 that yields co-product salt(s) 145 with respective strong acids(s) 130 (stage 222), e.g., base 142 may comprise ammonia and co-product salt as additional product 145 may comprise a nitrogen fertilizer 150 and/or base 142 may comprise choline, strong acid(s) 130 may comprise HCl and co-product salt as additional product 145 may comprise choline chloride as an animal feed supplement 150 (stage 224).

In various embodiments, controller 125 may be configured to repeat dissolving 210 and neutralizing 220 at least two or three times to yield the specified purity level of 99.99%, providing HPA 160, and/or controller 125 may be configured to repeat dissolving 210 and neutralizing 220 at least four or five times to yield the specified purity level of 99.999%, providing HPA 160 (stage 232).

Advantageously, some disclosed embodiments take advantage of the high purity aluminum used in aluminum-air batteries battery that may be converted to aluminum hydroxide, ATH, by electrolyte regeneration processes. When received from aluminum-air batteries, precipitated ATH may be contaminated with potassium/sodium from the regeneration process but retains the original aluminum high purity levels for other components (e.g., Fe, Si, etc.). In disclosed embodiments, the potassium/sodium contamination may be removed by dissolving the ATH in a strong acid such as hydrochloric (HCl), sulfuric (H₂SO₄) or nitric (HNO₃) to form the conjugate salt of aluminum and potassium/sodium in the solution. Consequently, neutralization to pH>4 precipitates ATH while keeping the potassium/sodium salt (e.g., potassium/sodium nitrate, sulfate and/or chloride) in solution. After filtering and washing, the precipitated solid ATH typically loses over 95% of the potassium/sodium contamination. The process may be repeated several times until a desired alumina purity is obtained, e.g., in certain embodiments, three purification stages may be required for 4N (99.99% pure) HPA and five to six purification stages may be required for 5N (99.999% pure) HPA.

The inventors note that while in typical chemical processing a low-cost chemical such as lime (CaO) or caustic soda (NaOH) may be used to neutralize the acidic salt solution, disclosed embodiments avoid using lime or caustic soda in order to avoid introduction of unwanted impurities (Ca or Na) in the HPA product. Instead, disclosed embodiments use neutralizing chemicals (bases) that produce viable co-product salts with the starting strong acid, avoiding discarding of the formed solution and preventing contamination of the HPA. In non-limiting examples, ammonia and/or choline bases may be used as the neutralization compounds, with co-products comprising nitrogen fertilizer chemicals (ammonium nitrate, sulfate and/or chloride) and/or animal feed supplements, such as choline chloride, respectively. Advantageously, disclosed embodiments yield both HPA and useful co-products from spent electrolyte of aluminum-air batteries. Advantageously, disclosed embodiments employ a multi-stage dissolution-reprecipitation process to remove potassium/sodium impurities from used electrolyte to yield HPA at prescribed quality (e.g., 4N, 5N, etc.). Proper selection of the acids and bases used in process further provide valuable co-product(s) such as fertilizers and/or feed supplements, rather than a waste salt solution. In contrast, existing processes such as alkoxide hydrolysis, alum decomposition and clay dissolution require complicated internal chemical processes to regenerate and recycle their working chemical (alcohol or acid) to avoid waste solution discharge/disposal.

In certain embodiments, neutralization of spent electrolyte by nitric acid (stage 210) to precipitate ATH, and re-dissolve the ATH into aluminum nitrate may be carried out according to the chemical reaction equation Al(OH)₃+3HNO₃→Al(NO₃)₃+3H₂O with concurrent K/Na salt (potassium/sodium nitrate) formation 135 according to the chemical reaction equation KOH+HNO₃→KNO₃+H₂O (for K). Neutralization of the acid (stage 220) may be carried out using ammonia as base 142, to precipitate pure ATH and to obtain ammonium nitrate (NH₄NO₃) that may be used as fertilizer, according to the chemical reaction equations Al(NO₃)₃+N H₄OH→Al(OH)₃↓+NH₄NO₃ and KNO₃+NH₄OH→KOH+N H₄NO₃ (for K). It is noted that while disclosed examples refer to K, equivalent compounds and reactions are applicable for Na (e.g., with aluminum air battery 90 operating with NaOH at least partly replacing KOH).

In certain embodiments, neutralization of spent electrolyte by hydrochloric acid (stage 210) to precipitate ATH, and re-dissolve the ATH into aluminum chloride may be carried out according to the chemical reaction equation A/(OH)₃+3HCl→AlCl₃+3H₂O with concurrent K/Na salt (potassium/sodium chloride) formation 135 according to the chemical reaction equation KOH+HCl→KCl+H₂O (for K). Neutralization of the acid (stage 220) may be carried out using choline as base 142, to precipitate pure ATH and to obtain choline chloride ((CH₃)₃N(Cl)CH₂CH₂OH) that may be used as feed supplement, according to the chemical reaction equations AlCl₃+(CH₃)₃NOH→Al(OH)₃↓+(CH₃)₃NCl and KCl+(CH₃)₃NOH→KOH+(CH₃)₃N(Cl)CH₂CH₂OH) (for K).

In the above description, an embodiment is an example or implementation of the invention. The various appearances of “one embodiment”, “an embodiment”, “certain embodiments” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention may also be implemented in a single embodiment. Certain embodiments of the invention may include features from different embodiments disclosed above, and certain embodiments may incorporate elements from other embodiments disclosed above. The disclosure of elements of the invention in the context of a specific embodiment is not to be taken as limiting their use in the specific embodiment alone. Furthermore, it is to be understood that the invention can be carried out or practiced in various ways and that the invention can be implemented in certain embodiments other than the ones outlined in the description above.

The invention is not limited to those diagrams or to the corresponding descriptions. For example, flow need not move through each illustrated box or state, or in exactly the same order as illustrated and described. Meanings of technical and scientific terms used herein are to be commonly understood as by one of ordinary skill in the art to which the invention belongs, unless otherwise defined. While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

1. The method of claim 5, wherein:
the metal hydroxide residues comprise aluminum tri-hydroxide (ATH) having potassium (K) and/or sodium (Na) impurities and the dissolving is configured to form an acidic ATH solution having pH<4,
the neutralizing of the acidic ATH solution to pH>4 is configured to precipitate ATH while retaining dissolved K/Na in the neutralized solution, and
the repeating of the dissolving and the neutralizing with the precipitated ATH is carried out until a specified purity level of the precipitated ATH is reached.

2. The method of claim 1, wherein the repeating is carried out at least two or three times to yield the specified purity level of 99.99%, and the method further comprises converting the 99.99%-pure ATH into high purity alumina (HPA).

3. The method of claim 1, wherein the repeating is carried out at least four or five times to yield the specified purity level of 99.999%, and the method further comprises converting the 99.99%-pure ATH into HPA.

4. The method of claim 1, wherein the ATH with K/Na impurities is provided by precipitation from spent electrolyte of an aluminum-air battery.

5. A method comprising:
dissolving metal hydroxide residues of metal air battery operations, having alkaline impurities, in at least one strong acid to form an acidic metal hydroxide solution having pH<4,
neutralizing the acidic metal hydroxide solution to pH>4 to precipitate metal hydroxide while retaining dissolved alkalinity in the neutralized solution, and
repeating the dissolving and the neutralizing with the precipitated metal hydroxide until a specified purity level of the precipitated metal hydroxide is reached.

6. The method of claim 5, wherein the at least one strong acid comprises at least one of hydrochloric (HCl), sulfuric (H₂SO₄) and nitric (HNO₃) acids.

7. The method of claim 5, wherein the neutralizing is carried out by a base that yields a co-product salt with the respective at least one strong acid.

8. The method of claim 7, wherein the base comprises ammonia and the co-product salt is a nitrogen fertilizer.

9. The method of claim 7, wherein the base comprises choline, the at least one strong acid comprises at least HCl, and the co-product salt is choline chloride as an animal feed supplement.

10. The system of claim 14, wherein:
the metal hydroxide residues comprise aluminum tri-hydroxide (ATH) having potassium (K) and/or sodium (Na) impurities and the at least one reactor is configured to form an acidic ATH solution having pH<4, and to neutralize the acidic ATH solution to pH>4 to precipitate ATH while retaining dissolved K/Na in the neutralized solution,
the retained dissolved alkalinity comprises the retained dissolved K/Na, and
the controller is configured to repeat the dissolving and the neutralizing with the precipitated ATH until a specified purity level of the precipitated ATH is reached.

11. The system of claim 10, wherein the controller is configured to repeat the dissolving and the neutralizing at least two or three times to yield the specified purity level of 99.99%, and wherein the system is further configured to convert the 99.99%-pure ATH into high purity alumina (HPA)

12. The system of claim 10, wherein the controller is configured to repeat the dissolving and the neutralizing at least four or five times to yield the specified purity level of 99.999%, and wherein the system is further configured to convert the 99.99%-pure ATH into HPA.

13. The system of claim 10, wherein the ATH with K/Na impurities is provided by precipitation from spent electrolyte of an aluminum-air battery.

14. A system comprising:
at least one reactor configured to dissolve metal hydroxide residues of metal air battery operations, having alkaline impurities, in at least one strong acid to form an acidic metal hydroxide solution having pH<4, and to neutralize the acidic metal hydroxide solution to pH>4 to precipitate metal hydroxide while retaining dissolved alkalinity in the neutralized solution,
pipework configured to deliver the at least one strong acid and at least one neutralizing base to the at least one reactor, and to remove the retained dissolved alkalinity in the neutralized solution from the at least one reactor, and
a controller configured to repeat the dissolving and the neutralizing with the precipitated metal hydroxide until a specified purity level of the precipitated metal hydroxide is reached.

15. The system of claim 14, wherein the at least one strong acid comprises at least one of hydrochloric (HCl), sulfuric (H₂SO₄) and nitric (HNO₃) acids.

16. The system of claim 14, wherein the neutralizing is carried out by a base that yields a co-product salt with the respective at least one strong acid.

17. The system of claim 16, wherein the base comprises ammonia and the co-product salt is a nitrogen fertilizer.

18. The system of claim 16, wherein the base comprises choline, the at least one strong acid comprises at least HCl, and the co-product salt is choline chloride as an animal feed supplement.

19. A method comprising:
dissolving aluminum tri-hydroxide (ATH) having potassium (K) and/or sodium (Na) impurities in at least one strong acid to form an acidic ATH solution having pH<4,
neutralizing the acidic ATH solution to pH>4 to precipitate ATH while retaining dissolved K/Na in the neutralized solution, and
repeating the dissolving and the neutralizing with the precipitated ATH until a specified purity level of the precipitated ATH is reached, and
converting the precipitated ATH into high purity alumina (HPA).

20. The method of claim 19, wherein the ATH with K/Na impurities is provided by precipitation from spent electrolyte of an aluminum-air battery and wherein the repeating is carried out at least two or three times to yield the specified purity level of 99.99%.
